(19) United States
(12) Patent Application Publication
(10) Pub. No.: US 2010/0211546 A1
(43) Pub. Date: Aug. 19, 2010

(54) System and method to backup data about devices in a network

(75) Inventors: Wojciech M. Grohman, Little Elm, TX (US); Darko Hadzidedic, Plano, TX (US)

Correspondence Address: Roger L. Maxwell PC, 3221 Amherst Avenue, Dalls, TX, 75225, US

(73) Assignee: Lennox Manufacturing Inc.

(21) Appl. No.: 12/378,394

(22) Filed: Feb. 13, 2009

(51) Int. Cl. G06F 17/30

(52) U.S. Cl. 707/640; 707/E17.005

(57) ABSTRACT

A system to backup data about a device in a network is disclosed. In a particular embodiment, the system includes a storage system for the data about the device in a controller, a first subsystem for determining that the data should be transferred to the device, and a second subsystem for transferring the data to the device for use.

### I. FIELD

The present disclosure is generally related to systems and methods to backup data about devices in a network.

### II. DESCRIPTION OF RELATED ART

A way to facilitate control of devices is to gather the devices and form a network. A network readily allows passing of data among connected devices.

Devices that are connected to form a network often include non-volatile data, such as operating control setup data, which is normally received or modified, or both received and modified, during a commissioning process (which generally happens any time a device's operational parameters are set).

At least two problems can arise with non-volatile device data. First, the data may become corrupted. Such corruption can disrupt any action involving that data. Second, a device in a network may be replaced with the same or an equivalent device, and the non-volatile data in the replacement device may not be precisely the data expected of such a device in the network. Unexpected data, like corrupted data, can disrupt actions involving that data.

It would be useful to have a system and method that provides a way to overcome such problems as corrupted data and unexpected data in devices in a network.

### III. SUMMARY

In a particular embodiment, a system to backup data for a device connected to a controller in a network is disclosed. The system includes a storage system for the data for the device in the controller, a first subsystem for determining that the data should be transferred to the device, and a second subsystem for transferring the data to the device for use.

In another particular embodiment, the storage system comprises non-volatile memory, and the system is designed so that a process is not terminated unless data is properly stored in the non-volatile memory.

In another particular embodiment, a method of backing up data for a device connected to a controller in a network is disclosed. The method includes the steps of transferring the data from the device to the controller, storing the data in the controller, determining that the data should be transferred back to the device for use; and transferring the data from the controller to the device for use.

One particular advantage provided by embodiments of the system and method to backup data about devices in a network is that data within devices can be corrected when it is determined that the data is corrupted. This ensures that all actions involving that data can be completed properly.

Another particular advantage provided by embodiments of the system and method to backup data about devices in a network is that unexpected device data, such as from a replacement device, can be replaced with expected data. This ensures that all actions involving that data can be completed properly.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram and flow chart of a particular illustrative embodiment of system and method to backup data about devices in a network;

FIG. 2 is a block diagram and flow chart of a particular illustrative embodiment of a system and method to backup data about devices in a network;

FIG. 3 is a block diagram and flow chart of a particular illustrative embodiment of communications among controllers in a system and method to backup data about devices in a network; and

FIG. 4 is a block diagram of a particular illustrative embodiment of storage of data in a controller in a system and method to backup data in devices in a network.

### V. DETAILED DESCRIPTION

Referring to FIG. 1, a particular illustrative embodiment of a system and method to backup data about devices in a network is disclosed and generally designated 100. Network 100 consists of a user interface or gateway 102, device 104 and subnet controllers 106 and 108.

User interface or gateway 102 is responsible for interacting with a user for system input and output. It can be a router or similar device that serves as an access point to another network. It can consist of a dot matrix monochrome or color touch-screen display, such as on a high-end HVAC system. It can consist of a combination of buttons and screen display, or a combination of touch-screen display and buttons. It can consist solely of collection of buttons that can be pushed by a user, such as on a remote controller.

Device 104 is a unit collected into a network. Device 104 is enabled to perform some function, such as modify the condition of air. In order to perform its function, device 104 must be configured, generally with non-volatile data.

Subnet controller 106 or 108 is responsible for system configuration, commissioning (e.g., setting operating parameters of equipment, loading names and settings of installer parameters and features as appropriate and configuring replacement parts) and control of any attached devices (e.g., device 104). Subnet controller 106 or 108 likely stores all system configuration information. Although shown in FIG. 1 to be an independent element, subnet controller 106 or 108 could exist in any device in the network. If more than one subnet controller exists in a network (i.e., if there is an active subnet controller 106 and an inactive subnet controller 108), a negotiation algorithm exists that decides which of the multiple subnet controllers takes over system responsibility and the other subnet controllers are put in listen only mode.

Network 100 may be any sort of network including a mechanism to allow someone to control the network (like user interface or gateway 102), a device (like device 104) and a controller (like active subnet controller 106 and possibly inactive subnet controller 108). For example, network 100 may be a heating, ventilating and air conditioning (HVAC) network with the user interface or gateway 102 being a touch screen on a thermostat, device 104 being a furnace, and the subnet controllers 106 being part of the aforementioned thermostat. Alternatively, network 100 could be a home security system. In such a case, controller 106 would likely be within a home security system panel that has installer screens 102 and device 104 would be a window or door sensor. Yet again alternatively, network 100 could be a home theater system. In that case, controller 106 would likely be a home automation controller with a touch pad 102 and the device 104 would be a television or sound system.

In a system and method to backup data about devices in a network, non-volatile data within and about the device 104 is stored within the subnet controllers 106 and 108. Then, for example, if the data within the device 104 becomes corrupted, the data within the subnet controllers 106 and 108 can be used to replace (or “restore”) the corrupt data.

In embodiments of the invention, the non-volatile data within and about the device 104 that is stored within the subnet controller 106 (and possibly subnet controller 108) is operating control data, such as settings of default and current heating rate, device nominal capacity, device part number, device serial number, default and current air volume for different stages of cooling, default and current heating profile, and similar information (v. network driver configuration data, such as device address, default subnet, default subnet mask, router address, and similar information). In embodiments of the invention, a subnet controller is able to download the aforementioned non-volatile operating control data to a replacement device or to a device containing corrupted information, to enable it to operate effectively immediately, without the need to reconfigure it.

FIG. 1 shows the backup process in some detail. Element 110, for example, shows that in a method to backup data about devices in a network the user interface or gateway first sends a message to the device 104 with a new value. At 112, the device 104 informs the user interface or gateway 102 that the new value is acceptable and has been changed. If the new value is not acceptable, as, for example, out of an acceptable range of values, the device can respond with its unchanged value, which will be retained in the user interface or gateway 102.

When the user interface or gateway 104 has its values updated, it can, as shown by element 114, relay the updated values to the active subnet controller 106. At 116 the active subnet controller 106 can acknowledge receiving and handling those updated values.

118 and 120 show that the user interface or gateway 102 can then relay the new values to any inactive subnet controller 108. There could be any number of inactive subnet controllers 108, and they could have any number of locations.

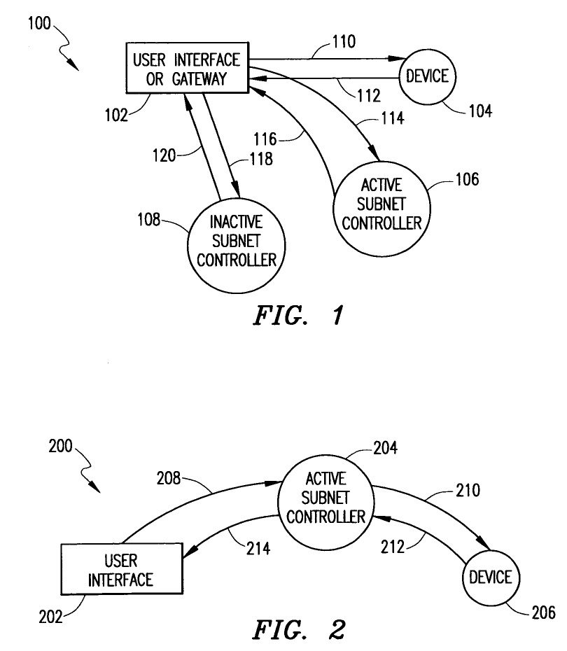

Referring to FIG. 2, a block diagram and flow chart of a particular illustrative embodiment of a system and method to backup data about devices in a network is disclosed and generally designated 200. FIG. 2 varies from FIG. 1 insofar as FIG. 1 shows an embodiment wherein a device 104 is first updated, and then an associated subnet controller 106 is updated and FIG. 2 shows an embodiment wherein a subnet controller 204 is first updated, and then an associated device 206 is updated. More specifically, FIG. 2 shows that a user interface 202 sends new values to an active subnet controller 204 via messages 208, the active subnet controller 204 updates the device 206 via messages 210, the device 206 acknowledges being updated via messages 212, and the active subnet controller 204 then acknowledges to the user interface 202 via messages 214 that the updating process has been done.

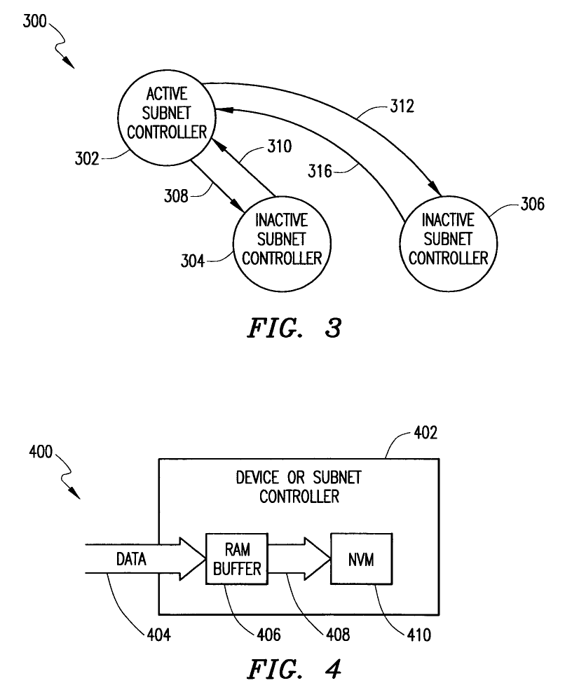

Referring to FIG. 3, a block diagram and flow chart of a particular illustrative embodiment of communications among controllers in a system and method to backup data about devices in a network is disclosed and generally designated 300. FIG. 3 illustrates a way by which an active subnet controller can update inactive subnet controllers. Whether an active subnet controller is updated after a device (as in FIG.1) or if it is updated before a device (as in FIG. 2), the active subnet controller 302 can update inactive subnet controllers 304 and 306 as shown. Specifically, messages 308 and 310 show updating and acknowledgement of a first inactive subnet controller 304 by an active subnet controller 302. Messages 312 and 316 show updating and acknowledgement of a second inactive subnet controller 306 by active subnet controller 302. There may be any number of inactive subnet controllers that are so updated. Further, the process shown in FIG. 3 can occur at any time, irrespective of the timing of any other updating process (such as shown in FIGS. 1 and 2).

To ensure that good data is always present in devices, it is prudent to never terminate a process, such as commissioning, unless you are certain that proper data is permanently stored. If, for example, you determine that the data in the device is fine, you can terminate a process. If, on the other hand, you determine that the data in the device is corrupted, you should not terminate commissioning, or a like process, until you are satisfied that the data is stored in non-volatile memory (NVM), not just random access memory (RAM); that is, until you are certain that the proper data is permanently stored.

FIG. 4 illustrates this process. Element 402 shows a memory for either a device or a subnet controller. In embodiments of the invention, data goes to memory 402. This data is first stored in a RAM buffer 406 where it is temporarily stored. This storing of data temporarily happens virtually immediately upon receipt. The data is subsequently transferred to NVM 410 where it is permanently stored. The transfer of data 408 from RAM to NVM can occur anytime subsequent to it being received. Storing of data in NVM 410 could happen totally in the “background,” well after it was first stored in the RAM buffer 406. In embodiments of the invention it is imprudent to exist a process such as commissioning (either for configuration or verification purposes) unless proper data is stored in NVM as shown.

The system and method of the present invention offer a number of advantages over the prior art. They provide ways in which problems arising from corrupted data and unexpected data (from replacement devices) can be prevented in networks. The system and method of the present invention enable networks to backup data about connected devices and to correct data that becomes corrupted. This ensures that all actions involving that data can be completed properly. Likewise, the system and method of the present invention enable networks to backup data in a network so that unexpected data, such as from a replacement device, can be replaced with expected data. This ensures that all actions involving that data can be completed properly.

Those of skill will appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), magnetoresistive random access memory (MRAM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system for backing up operating control data about a device connected to a controller in a network, comprising:
a storage system for the data about the device in the controller;
a first subsystem for determining that the data should be transferred to the device; and
a second subsystem for transferring the data to the device for use.

2. The system of claim 1, wherein the controller is a subnet controller.

3. The system of claim 2, wherein the controller is an active subnet controller.

4. The system of claim 1, further comprising an inactive subnet controller.

5. The system of claim 4, wherein the storage subsystem for the data about the device in the controller is a first storage subsystem, and wherein the inactive subnet controller has a second storage subsystem for the data about the device.

6. The system of claim 1, wherein the second subsystem interconnects a user interface and the device.

7. The system of claim 1, wherein the second subsystem interconnects the controller and the device.

8. The system of claim 1, wherein the storage subsystem includes non-volatile memory.

9. A method for backing up operating control data for a device connected to a controller in a network, comprising the steps of:
transferring the data from the device to the controller;
storing the data in the controller;
determining that the data should be transferred back to the device for use; and
transferring the data from the controller to the device for use.

10. The method of claim 9, wherein the method is performed with a user interface or gateway.

11. The method of claim 9, wherein the method is performed with a thermostat.

12. The method of claim 9, wherein the controller is a subnet controller.

13. The method of claim 9, wherein the controller has non-volatile memory, and wherein the storing of data is storing the data in the non-volatile memory.

14. The method of claim 13, further comprising the step of not terminating any process until the data is stored in the non-volatile memory.

15. The method of claim 14, wherein the process is a commissioning process.

16. The method of claim 15, wherein the commissioning process involves network configuration.

17. The method of claim 15, wherein the commissioning process involves network verification.

18. The method of claim 9, further comprising an inactive subnet controller.

19. The method of claim 18, further comprising the step of storing the data in the inactive subnet controller.

20. The method of claim 9, wherein the data is transferred from a user interface to the device.

21. The method of claim 9, wherein the data is transferred from a controller to the device.
